(19) United States
(12) Patent Application Publication
(10) Pub. No.: US 2009/0043429 A1
(43) Pub. Date: Feb. 12, 2009

(54) Control device and control method of vehicle

(75) Inventor: Hideto Minekawa, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/988,645

(22) PCT Filed: Sep. 21, 2006
(86) PCT No.: PCT/JP2006/319235

§ 371 Date: Jan. 11, 2008

(30) Foreign Application Priority Data
Oct. 11, 2005 (JP) 2005-296209

(51) Int. Cl. F02N 11/08

(52) U.S. Cl. 701/1

(57) ABSTRACT

An ecorun ECU executes a program including the steps of: starting operation of an electric fan if an air-conditioner refrigerant pressure is higher than a pressure threshold value or an inverter coolant temperature is higher than a temperature threshold value and if the electric fan is not operating; restarting an engine by prohibiting temporary stop of the engine if the engine is not operating; and performing charging processing if SOC of a battery is lower than an SOC threshold value.

### TECHNICAL FIELD

The present invention relates to control suitable for a vehicle, for temporarily stopping an engine when a predetermined condition is satisfied during idling, and particularly to control of a vehicle, for controlling a cooling fan driven by the engine

### BACKGROUND ART

From a viewpoint of prevention of global warming and resource saving, an idling stop system (also referred to as an economy running (ecorun) system and an engine automatic stop and start system) causing an engine to automatically stop when the vehicle stops at the red light at an intersection or the like and permitting the engine to restart when a driver performs an operation to start running again (for example, by pressing down an accelerator pedal, by stopping pressing down of a brake pedal, or by switching a shift lever to a forward drive position) has been put into practical use According to such a system, when the engine is restarted, a crankshaft is rotated by means of a motor such as a motor-generator or a starter-motor using power from a secondary battery mounted on the vehicle

In such an idling stop system, it is necessary to exert control such that, when various sensor signals or switch signals are detected and a predetermined condition for starting idling stop is satisfied, the engine is stopped and thereafter the engine is again started

The engine mounted on the vehicle is cooled by a coolant The coolant that has received heat from engine is fed to a radiator, in which heat exchange with air is performed so that the coolant is cooled Then, the coolant is again supplied to the engine In order to improve efficiency in heat exchange in the radiator, a cooling fan is provided in the radiator Some cooling fans are configured such that a rotation shaft of the cooling fan is connected to a crankshaft of the engine and the cooling fan is driven by the rotation force of the engine (hereinafter, such a fan may be referred to as a mechanical fan, relative to an electric fan)

In the above-described idling stop system, as the mechanical fan stops when the engine stops, cooling airflow stops and cooling function is significantly lowered Such heat retention while the engine is stopped has not been addressed, and the problem of overheat due to heat retention resulting from frequent engine start and stop has arisen Japanese Patent Laying-Open No 2003-237384 discloses a cooling apparatus for an industrial vehicle that solves such a problem In the cooling apparatus, an electric fan that operates for a prescribed time period from the time point of engine stop by means of a timer that operates for a prescribed time period from the time point of turn-off of an engine key is provided in an upper portion of a hood

According to the cooling apparatus for the industrial vehicle, the heat retained in an engine room is dissipated by the electric fan after the engine stops, so that an oil temperature, a coolant temperature and the like at the time of next engine start can be lowered, thus mitigating disadvantageous overheat

On the other hand, while the engine is stopped, cooling performance only with the electric fan is insufficient, and the oil temperature and the coolant temperature cannot sufficiently be lowered in some cases If satisfactory cooling performance is to be achieved in such a case, the electric fan tends to be greater in size

### DISCLOSURE OF THE INVENTION

The present invention was made to solve the above-described problems, and an object of the present invention is to provide a control device and a control method of a vehicle capable of sufficiently cooling a cooled object while avoiding a greater size of a cooling fan, in a vehicle provided with a system temporarily stopping an engine when a state of the vehicle satisfies a predetermined condition and thereafter restarting the engine

A control device according to the present invention controls a vehicle provided with a system temporarily stopping an engine when a state of the vehicle satisfies a predetermined condition The vehicle is provided with a cooling fan for cooling a heat exchanger, mechanically driven by the engine The control device includes a detection unit detecting a state of a cooled object and a control unit controlling temporary stop of the engine based on the detected state of the cooled object

According to the present invention, if a predetermined condition is satisfied when the vehicle temporarily stops at the red light at the intersection, the engine is temporarily stopped If the condition is no longer satisfied, the engine is restarted The cooling fan mechanically driven by the engine supplies cooling airflow to an engine radiator, an HV radiator for electric equipment, and a condenser serving as a radiator for air-conditioner The control device causes the cooling fan to operate, such that, if it is determined that cooling is highly demanded based on the state of the cooled object, temporary stop of the engine is not carried out even though the predetermined condition is satisfied, or if the engine is temporarily stopped, the engine is restarted Therefore, the cooled object is sufficiently cooled by means of the cooling fan When the electric fan is also provided and when cooling is highly demanded, it is not that only the electric fan supplies the cooling airflow, but that the cooling fan driven by the engine is operated without stopping the engine Accordingly, a greater size of the electric fan can be avoided If the electric fan is also provided and if the electric fan alone is provided, the problem of power consumption of the electric fan may arise Even in such a case, when cooling is highly demanded, the cooling fan driven by the engine is operated without stopping the engine, and therefore, excessive power consumption of the electric fan can be avoided Consequently, a control device of a vehicle, capable of sufficiently cooling a cooled object while avoiding a greater size of a cooling fan in the vehicle provided with a system temporarily stopping an engine when a state of the vehicle satisfies a predetermined condition and thereafter restarting the engine, can be provided Preferably, the control unit prohibits stop of the engine by restarting the engine if the engine is temporarily stopped

According to the present invention, stop of the engine is prohibited, so that the cooling fan continues operating and sufficient cooling performance can be ensured

Further preferably, the detection unit detects a state of electric equipment mounted on the vehicle

According to the present invention, an inverter and a DC/DC converter representing the electric equipment for hybrid drive mounted on the vehicle are cooled by the coolant, and heat exchange between the coolant and the outside air is carried out in the HV radiator If cooling is highly demanded by such electric equipment, the cooling fan is operated without stopping the engine, so that cooling airflow is supplied to the HV radiator and sufficient cooling performance can be ensured

Further preferably, the detection unit detects a state of air-conditioning equipment mounted on the vehicle

According to the present invention, heat exchange between an air-conditioner refrigerant and the outside air is carried out in a condenser serving as a radiator for the air-conditioner mounted on the vehicle If cooling is highly demanded by the air-conditioner, the cooling fan is operated without stopping the engine, so that cooling airflow is supplied to the condenser and sufficient cooling performance can be ensured

Further preferably, the detection unit detects a state of the engine

According to the present invention, the engine is cooled by the coolant, and heat exchange between the coolant and the outside air is carried out in the engine radiator If cooling is highly demanded by the engine, the cooling fan is operated without stopping the engine, so that cooling airflow is supplied to the engine radiator and sufficient cooling performance can be ensured

Further preferably, the detection unit is implemented by a sensor detecting a temperature

According to the present invention, for example, a temperature of the engine, a temperature of the engine coolant, a temperature of the electric equipment, a temperature of HV coolant, and the like are detected, so that the state of the electric equipment, the state of the engine and the like can be detected

Further preferably, the control device causes charging of a power storage mechanism mounted on the vehicle while stop of the engine is prohibited

According to the present invention, a generator or an alternator is operated by means of the engine while stop of the engine is prohibited, so that electric power can be generated and the battery or the like serving as the power storage mechanism can be charged An embodiment preferable in terms of energy efficiency can thus be achieved

### BRIEF DESCRIPTION OF THE DRAWINGS

FIG. 1 is a control block diagram of an idling stop system according to a first embodiment of the present invention

FIG. 2 is a flowchart showing a control configuration of a program executed by an ecorun ECU in FIG. 1

FIG. 3 is a control block diagram of an idling stop system according to a second embodiment of the present invention

FIG. 4 is a flowchart showing a control configuration of a program executed by an ecorun ECU in FIG. 3

### BEST MODES FOR CARRYING OUT THE INVENTION

An embodiment of the present invention will be described hereinafter with reference to the drawings In the description below, the same elements have the same reference characters allotted, and their label and function are also identical Therefore, detailed description thereof will not be repeated

### First Embodiment

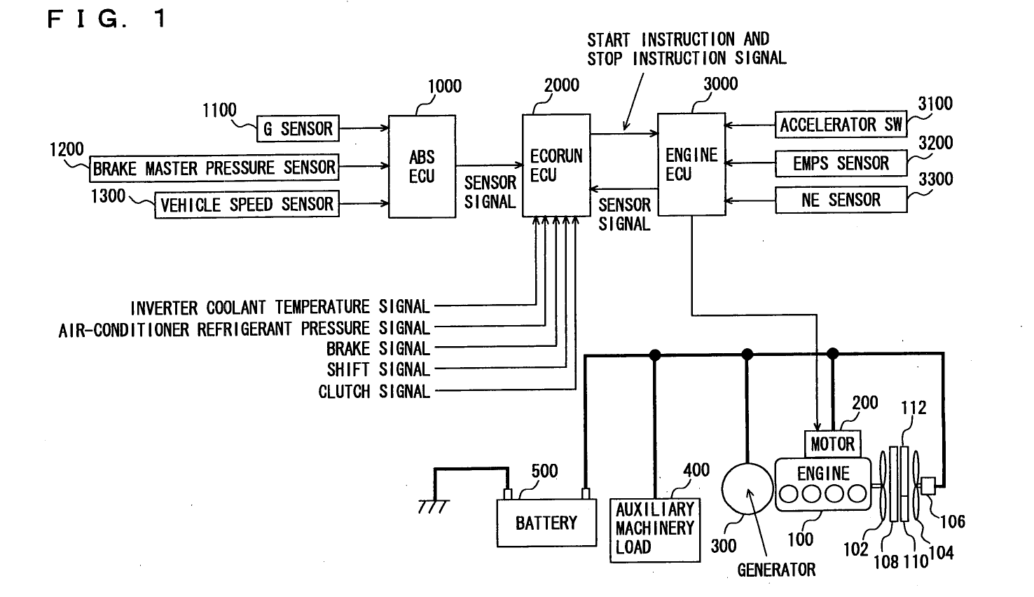

A control block of a vehicle including an idling stop system to which a control device according to the present embodiment is applied will be described with reference to FIG. 1

An engine 100, a motor 200 cranking engine 100 in order to start and restart engine 100 (initiation of engine 100 using an ignition switch is referred to as “start”, and initiation of engine 100 after it is temporarily stopped for idling stop is referred to as “restart”), a generator 300 connected to a crankshaft pulley of engine 100 through a belt, an auxiliary machinery load 400 such as a light, an audio apparatus and a compressor for the air-conditioner, and a battery (secondary battery) 500 supplying electric power to motor 200 and auxiliary machinery load 400 are included as a hardware system to be controlled in the vehicle provided with the idling stop system Here, a motor-generator may be provided instead of motor 200, or a battery for supplying electric power while engine 100 is stopped may further be provided Alternatively, a capacitor or the like may be provided instead of the battery Motor 200 can not only carry out cranking at the time of restart, but also assist engine 100 during running of the vehicle

The idling stop system includes an ABS (Antilock Braking System)_ECU (Electronic Control Unit) 1000, an ecorun ECU 2000, and an engine ECU 3000, as a control system for controlling such a hardware system

A signal from a G sensor 100 (a signal of physical value representing inclination and acceleration of the vehicle), a signal from a brake master pressure sensor 1200 (a signal of physical value representing braking performance of a brake apparatus of the vehicle), and a signal from a vehicle speed sensor 1300 (a signal of physical value representing a speed of the vehicle) are input to ABS_ECU 1000

A brake signal in synchronization with a brake light signal and indicating that the brake is being applied, a shift signal indicating a shift position of a transmission, and a clutch signal indicating an operation state of the clutch are input to ecorun ECU 2000

A signal from an accelerator switch 3 100 detecting pressing down of an accelerator pedal, a signal from an EMPS (Electronic Motor Power Steering) sensor 3200 detecting manipulation of a steering wheel, and a signal from an NE sensor 3300 detecting an engine speed (NE) of engine 100 are input to engine ECU 3000

In addition, a sensor signal is transmitted from ABS_ECU 1000 to ecorun ECU 2000, a start instruction signal and a stop instruction signal for engine 100 are transmitted from ecorun ECU 2000 to engine ECU 3000, and a sensor signal is transmitted from engine ECU 3000 to ecorun ECU 2000 Engine ECU 3000 transmits a start signal to motor 200 based on the start instruction signal for engine 100 received from ecorun ECU 2000, so that motor 200 cranks engine 100 and engine 100 restarts

Moreover, while engine 100 is operating, ecorun ECU 2000 controls generator 300 so that the processing for charging battery 500 is performed Here, it is assumed that motor 200 and generator 300 are driven through a not shown inverter or a DC/DC converter

The vehicle is provided with an engine cooling system for cooling engine 100, an HV cooling system for cooling electrical components (such as the inverter, the DC/DC converter, and the like), and an air-conditioner cooling system for cooling a condenser serving as a radiator in a refrigeration cycle of the air-conditioner

The engine cooling system includes as main components, a mechanical fan 102 driven by engine 100 and a radiator 112 for engine cooling The HV cooling system includes as main components, mechanical fan 102 driven by engine 100 (this mechanical fan 102 is shared for use by the engine cooling system and the HV cooling system) and a radiator 110 for HV cooling The air-conditioner cooling system includes as main components, mechanical fan 102 driven by engine 100 (this mechanical fan 102 is shared for use by the engine cooling system and the air-conditioner cooling system) and a condenser 108

Further, an electric fan 104 driven by a motor 106 is provided in addition to mechanical fan 102, in the vehicle controlled by the control device according to the present embodiment

It is noted that arrangement of the equipment in the cooling system (the engine cooling system, the HV cooling system and the air-conditioner cooling system) shown in FIG. 1 is schematic only, and positional relation shown in FIG. 1 has nothing to do with a forward-rear direction and a left-right direction of the vehicle

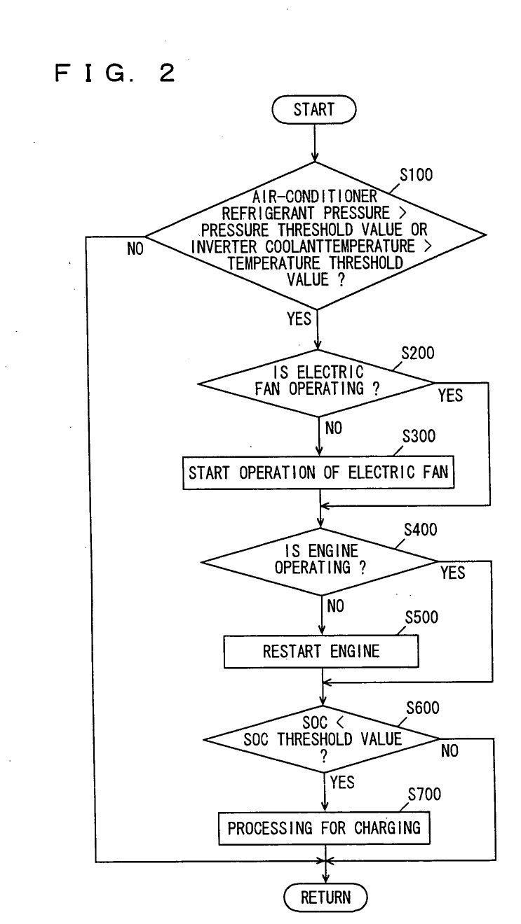

A control configuration of a program executed by the ecorun ECU in FIG. 1 will be described with reference to the flowchart in FIG. 2 The program may be executed by an ECU other than the ecorun ECU In addition, execution of the program is repeated at predetermined cycle time intervals

In step (hereinafter, step is abbreviated as S) 100, ecorun ECU 2000 determines whether an air-conditioner refrigerant pressure is higher than a pressure threshold value or whether an inverter coolant temperature is higher than a temperature threshold value Here, ecorun ECU 2000 makes determination based on an air-conditioner refrigerant pressure signal and an inverter coolant temperature signal input to ecorun ECU 2000 If the air-conditioner refrigerant pressure is higher than the pressure threshold value or if the inverter coolant temperature is higher than the temperature threshold value (YES in S100), the process proceeds to S200 Otherwise (NO in S100), the process ends

In S200, ecorun ECU 2000 determines whether electric fan 104 is operating or not Here, it is assumed that motor 106 driving electric fan 104 is controlled by ecorun ECU 2000 If it is determined that electric fan 104 is operating (YES in S200), the process proceeds to S400 Otherwise (NO in S200), the process proceeds to S300

In S300, ecorun ECU 2000 transmits a drive instruction signal to motor 106 of electric fan 104, so as to start operation of electric fan 104

In S400, ecorun ECU 2000 determines whether engine 100 is operating or not If it is determined that engine 100 is operating (YES in S400), the process proceeds to S600 Otherwise (NO in S400), the process proceeds to S500

In S500, ecorun ECU 2000 restarts engine 100 that has been stopped in the idling state

In S600, ecorun ECU 2000 determines whether SOC (States Of Charge) of battery 500 is lower than an SOC threshold value Here, SOC of battery 500 is calculated by ecorun ECU 2000 based on summation of an open-circuit voltage and an amount of charging/discharging current of battery 500 If the SOC of battery 500 is lower than the SOC threshold value (YES in S600), the process proceeds to S700 Otherwise (NO in S600), the process ends

In S700, ecorun ECU 2000 controls generator 300, the inverter and the DC/DC converter, so that the charging processing is performed and battery 500 is charged

An operation of the idling stop system based on the configuration and the flowchart above will now be described

While the drive system is operating including during running of the vehicle and during idling stop (for example, corresponding to a state of the ignition switch or a switch similar to the ignition switch), the air-conditioner refrigerant pressure or the inverter coolant temperature is detected and the detected result is compared with the threshold value (S100) If the load of the air-conditioner (it is assumed that cooling is performed) is high and the air-conditioner refrigerant pressure is higher than the pressure threshold value or if load of motor 200 or the like is high (for example, a case that engine 100 is assisted by motor 200 or the like) and the inverter coolant temperature is higher than the temperature threshold value (YES in S100) and if electric fan 104 is not operating (NO in S200), the operation of electric fan 104 is started (S300)

Even in the idling stop state in which engine 100 is stopped, the cooling airflow can thus be fed to engine cooling radiator 112, HV cooling radiator 110 and condenser 108, thereby achieving desired cooling performance

In addition, if electric fan 104 is operating (YES in S200) and if engine 100 is not operating (NO in S400), engine 100 is restarted (S500) Here, electric fan 104 may continue to operate or may stop operating, and electric fan 104 may be controlled based on the state of the cooled object During the operation of engine 100, if SOC of battery 500 is low (YES in S600), the processing for charging battery 500 is performed (S700)

In this manner, if engine 100 is stopped in the idling state after SOC of battery 500 is lowered due to operation of electric fan 104 or after the vehicle runs with engine 100 being assisted by motor 200 (as can be seen from the fact that the temperature of the inverter is high), cooling is demanded (YES m S100), engine 100 is restarted, and the processing for charging battery 500 is performed (S700) As a result of restart of engine 100, mechanical cooling fan 104 starts operating, so that cooling performance is enhanced and the cooled object can sufficiently be cooled In addition, lowering in SOC of battery 500 can be recovered through the charging processing

As described above, according to the ecorun ECU serving as the control device of the present embodiment, the engine, the electric equipment, and the condenser of the air-conditioner, that are objects to be cooled, can sufficiently be cooled while avoiding a greater size of a cooling fan, in a vehicle provided with the idling stop system temporarily stopping the engine when a state of the vehicle satisfies a predetermined condition and thereafter restarting the engine Particularly, even if an amount of electric power stored in the power storage mechanism such as a battery is low, the present embodiment can suitably be applied

### Second Embodiment

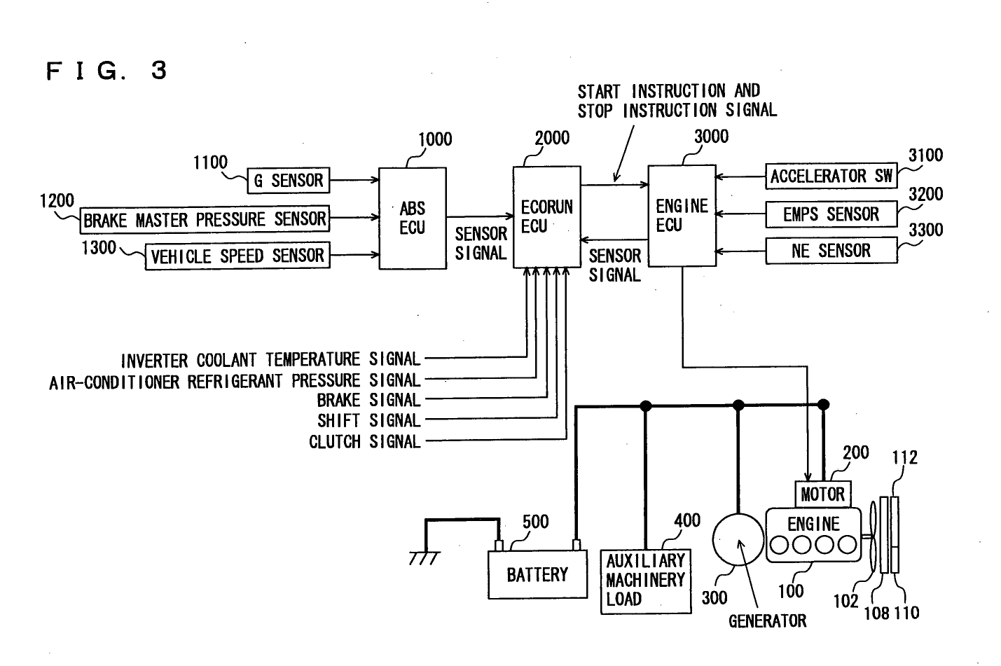

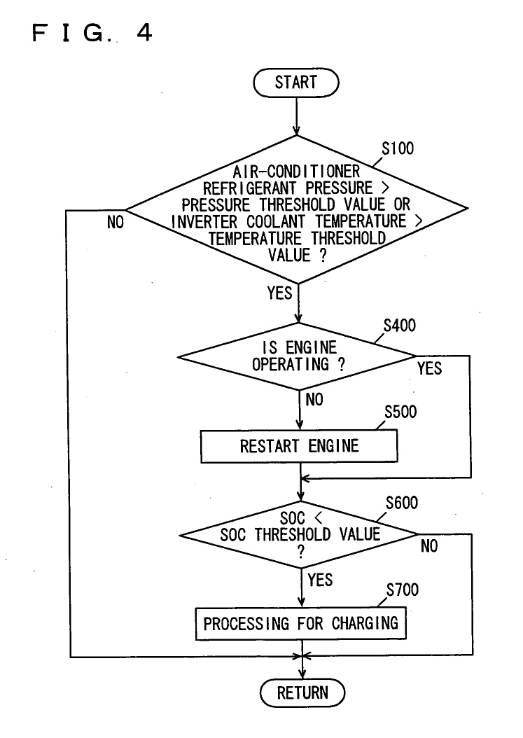

A second embodiment of the present invention will be described hereinafter FIG. 3 showing a hardware configuration corresponds to FIG. 1, and FIG. 4 showing a program flowchart corresponds to FIG. 2

In the hardware of the vehicle provided with the idling stop system according to the present embodiment shown in FIG. 3 corresponding to FIG. 1, the electric fan provided in the first embodiment is not present The hardware configuration is otherwise the same as in the first embodiment, and the same element has the same reference character allotted Therefore, detailed description will not be repeated

The flowchart of the program executed by ecorun ECU 2000 of the vehicle provided with the idling stop system according to the present embodiment, shown m FIG. 4 corresponding to FIG. 2, does not include S200 and S300 In FIG. 2, because the electric fan is not present The processing is otherwise the same as in the first embodiment, and the same processing has the same step number allotted Therefore, detailed description will not be repeated

As described above, in the present embodiment, even when the electric fan is not provided although the mechanical fan is provided, the engine, the electric equipment, and the condenser of the air-conditioner, that are objects to be cooled, can sufficiently be cooled while avoiding a greater size of a cooling fan, in a vehicle provided with the idling stop system temporarily stopping the engine when a state of the vehicle satisfies a predetermined condition and thereafter restarting the engine

It is noted that the inverter coolant temperature in the flowchart may be replaced with a temperature of a power element of the inverter or a coil temperature of the motor (or an alternative temperature thereof)

It should be understood that the embodiments disclosed herein are illustrative and non-restrictive in every respect The scope of the present invention is defined by the terms of the claims, rather than the description above, and is intended to include any modifications within the scope and meaning equivalent to the terms of the claims

1. A control device of a vehicle provided with a system temporarily stopping an engine when said engine is in an idle state and a state of the vehicle satisfies a predetermined condition, said vehicle being provided with a cooling fan mechanically driven by said engine, comprising:
a detection unit detecting a state of a cooled object; and
a control unit controlling temporary stop of said engine by said system based on said detected state of the cooled object and on said state of the vehicle.

2. The control device of a vehicle according to claim 1, wherein
said control unit prohibits stop of said engine by restarting said engine if said engine is temporarily stopped.

3. The control device of a vehicle according to claim 1, wherein
said detection unit detects a state of electric equipment mounted on the vehicle.

4. The control device of a vehicle according to claim 3, wherein
said detection unit is implemented by a sensor detecting a temperature.

5. The control device of a vehicle according to claim 1, wherein
said detection unit detects a state of air-conditioning equipment mounted on the vehicle.

6. The control device of a vehicle according to claim 5, wherein
said detection unit is implemented by a sensor detecting a temperature.

7. The control device of a vehicle according to claim 1, wherein
said detection unit detects a state of said engine.

8. The control device of a vehicle according to claim 7, wherein
said detection unit is implemented by a sensor detecting a temperature.

9. The control device of a vehicle according to claim 1, causing charging of a power storage mechanism mounted on the vehicle while said control unit prohibits stop of said engine.

10. A control device of a vehicle provided with a system temporarily stopping an engine when said engine is in an idle state and a state of the vehicle satisfies a predetermined condition, said vehicle being provided with a cooling fan mechanically driven by said engine, comprising:
detection means for detecting a state of a cooled object; and
control means for controlling temporary stop of said engine by said system based on said detected state of the cooled object and on said state of the vehicle.

11. The control device of a vehicle according to claim 10, wherein
said control means includes means for prohibiting stop of said engine by restarting said engine if said engine is temporarily stopped.

12. The control device of a vehicle according to claim 10, wherein
said detection means includes means for detecting a state of electric equipment mounted on the vehicle.

13. The control device of a vehicle according to claim 12, wherein
said detection means includes means for detecting a temperature.

14. The control device of a vehicle according to claim 10, wherein
said detection means includes means for detecting a state of air-conditioning equipment mounted on the vehicle.

15. The control device of a vehicle according to claim 14, wherein
said detection means includes means for detecting a temperature.

16. The control device of a vehicle according to claim 10, wherein
said detection means includes means for detecting a state of said engine.

17. The control device of a vehicle according to claim 16, wherein
said detection means includes means for detecting a temperature.

18. The control device of a vehicle according to claim 10, further comprising charge means for charging a power storage mechanism mounted on the vehicle while said control means prohibits stop of said engine.

19. A method of controlling a vehicle provided with a system temporarily stopping an engine when said engine is in an idle state and a state of the vehicle satisfies a predetermined condition, said vehicle being provided with a cooling fan mechanically driven by said engine, comprising the steps of:
detecting a state of a cooled object; and
controlling temporary stop of said engine by said system based on said detected state of the cooled object and on said state of the vehicle.

20. The method of controlling a vehicle according to claim 19, wherein
said step of controlling temporary stop of said engine includes the step of prohibiting stop of said engine by restarting said engine if said engine is temporarily stopped.

21. The method of controlling a vehicle according to claim 19, wherein
said step of detecting a state includes the step of detecting a state of electric equipment mounted on the vehicle.

22. The method of controlling a vehicle according to claim 21, wherein
said step of detecting a state includes the step of detecting a temperature.

23. The method of controlling a vehicle according to claim 19, wherein
said step of detecting a state includes the step of detecting a state of air-conditioning equipment mounted on the vehicle.

24. The method of controlling a vehicle according to claim 23, wherein
said step of detecting a state includes the step of detecting a temperature.

25. The method of controlling a vehicle according to claim 19, wherein
said step of detecting a state includes the step of detecting a state of said engine.

26. The method of controlling a vehicle according to claim 25, wherein
said step of detecting a state includes the step of detecting a temperature.

27. The method of controlling a vehicle according to claim 19, further comprising the step of charging a power storage mechanism mounted on the vehicle while stop of said engine is prohibited.
